(19) United States
(12) Patent Application Publication
(10) Pub. No.: US 2026/0213592 A1
(43) Pub. Date: Jul. 23, 2026

(54) MOTOR

(71) Applicant: Panasonic Intellectual Property Management Co., Ltd., Osaka (JP)

(72) Inventors: Atsufumi KIKUCHI, Osaka (JP); Hiroshi YAMAMOTO, Osaka (JP); Takehiko YAMAKAWA, Osaka (JP); Kazuyuki SAKIYAMA, Osaka (JP)

(21) Appl. No.: 19/140,944

(22) PCT Filed: Jan. 12, 2024
(86) PCT No.: PCT/JP2024/000693

§ 371 Date: Jun. 18, 2025

(30) Foreign Application Priority Data
Jan. 17, 2023 (JP) 2023-005304

(51) Int. Cl. H02K 1/2706; H02K 1/14; H02K 3/18

(52) U.S. Cl. CPC H02K 1/2706; H02K 1/14; H02K 3/18

(57) ABSTRACT

A rotor included in a motor according to the present disclosure includes a rotor yoke and a plurality of magnets. The plurality of magnets are arranged on a side surface of the rotor yoke to surround the circumference of the rotor yoke. Each of the plurality of winding wires is wound around a corresponding one of a plurality of teeth. Each of the plurality of winding wires is formed by winding, in multiple layers, a wire having a flat and rectangular shape. Each of the plurality of winding wires has a plurality of layers stacked one on top of another in a direction in which a corresponding one of the plurality of teeth protrudes. Each of the plurality of winding wires has a cutout provided for one or more layers including a layer closest to the rotor which belong to the plurality of layers.

### TECHNICAL FIELD

The present disclosure generally relates to a motor. More particularly, the present disclosure relates to a motor including: a rotor with magnets arranged thereon; and a stator, around which winding wires are wound.

### BACKGROUND ART

Patent Literature 1 discloses a rotating electrical machine including a stator and a rotor disposed inside the stator. The stator includes: a stator core having a plurality of teeth which are arranged at intervals around the circumference of an annular yoke to protrude radially inward from the yoke; and a plurality of concentrated winding coils, each of which is formed by winding a winding wire around a corresponding one of the plurality of teeth.

In this type of rotating electrical machine, a leakage flux emitted from a rotor magnet is interlinked with the winding wires, thereby causing an eddy current, and consequently causing eddy current loss. The rotating electrical machine described in Patent Literature 1 provides a recess for each of the teeth of the stator to reduce the magnetic flux interlinked with the winding wires, thereby eventually cutting down the eddy current loss.

The rotating electrical machine (i.e., motor) described in Patent Literature 1 would cause an increased loss due to an increase in the iron loss involved with those recesses provided for the teeth of the stator in order to reduce the eddy current loss.

### CITATION LIST

### Patent Literature

Patent Literature 1: JP 2017-77046 A

### SUMMARY OF INVENTION

An object of the present disclosure is to provide a motor that allows for reducing the loss more sufficiently.

A motor according to an aspect of the present disclosure includes a rotor and a stator. The rotor includes: a rotor yoke having the shape of a column and including a rotary shaft; and a plurality of magnets arranged on a side surface of the rotor yoke to surround the circumference of the rotor yoke. The rotary shaft has a rotational axis thereof defined by a center axis. The stator includes: a stator yoke arranged to be concentric with the rotor and having the shape of a cylinder; a plurality of teeth; and a plurality of winding wires. The plurality of teeth protrude toward the rotary shaft from a plurality of points on the inner circumferential surface of the stator yoke. The plurality of points are set to face the circumference of the rotor yoke. Each of a plurality of winding wires is wound around a corresponding one of the plurality of teeth. Each of the plurality of winding wires is formed by winding, in multiple layers, a wire having a flat and rectangular shape. Each of the plurality of winding wires has a plurality of layers stacked one on top of another in a direction in which a corresponding one of the plurality of teeth protrudes. Each of the plurality of winding wires has a cutout provided for one or more layers including a layer closest to the rotor which belong to the plurality of layers.

### BRIEF DESCRIPTION OF DRAWINGS

FIG. 1 is a perspective view of a motor according to an embodiment of the present disclosure;

FIG. 2 is a top view of the motor;

FIG. 3 is a cross-sectional view, taken along the plane A-A shown in FIG. 2, of the motor;

FIG. 4 is a perspective view of a part of the motor in which a stator and a rotor are facing each other;

FIG. 5 is a front view of a winding wire included in the motor;

FIG. 6 is a perspective view of the winding wire included in the motor;

FIG. 7 is a perspective view of a winding wire included in a motor according to a first variation;

FIG. 8 is a perspective view of another winding wire included in a motor according to the first variation;

FIG. 9 is a perspective view of still another winding wire included in a motor according to the first variation;

FIG. 10 is a perspective view of a winding wire included in a motor according to a second variation;

FIG. 11 is a perspective view of a winding wire included in a motor according to a third variation;

FIG. 12 is a perspective view of a winding wire included in a motor according to a fourth variation;

FIG. 13 is a perspective view of a winding wire included in a motor according to a fifth variation;

FIG. 14 is a perspective view of another winding wire included in a motor according to a fifth variation; and

FIG. 15 is a perspective view of a winding wire included in a motor according to a sixth variation.

### DESCRIPTION OF EMBODIMENTS

### Embodiment

A motor according to an embodiment of the present disclosure will be described in detail with reference to the accompanying drawings. Note that the configuration to be described below is only an exemplary one of various embodiments of the present disclosure and should not be construed as limiting. Rather, the exemplary embodiment may be readily modified in various manners depending on a design choice or any other factor without departing from a true spirit and scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### (1) Overview

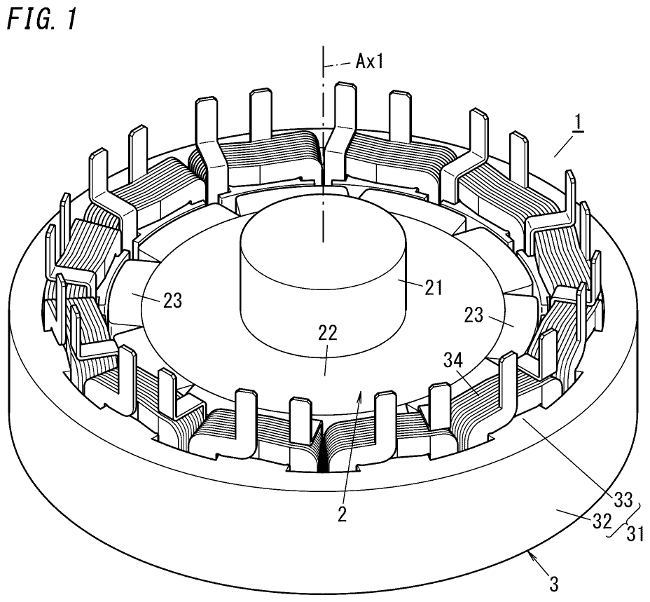

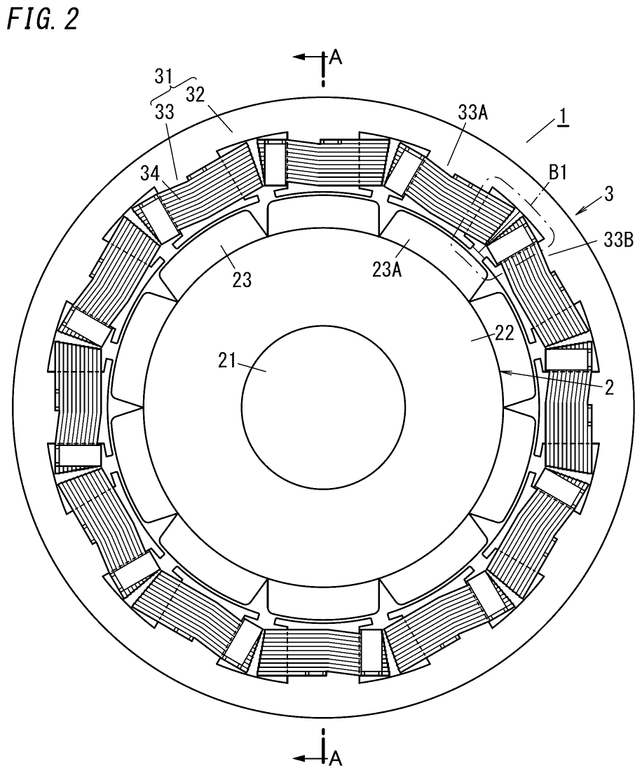

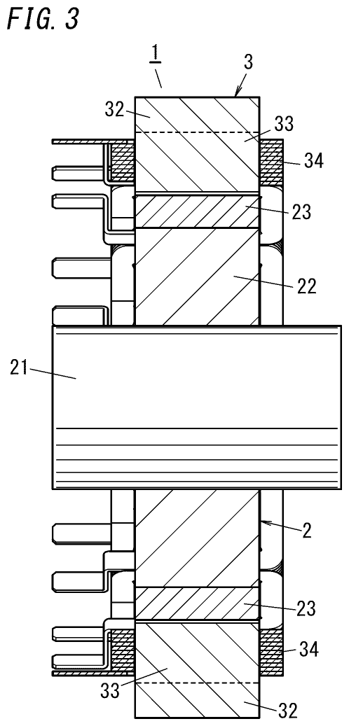

FIG. 1 is a perspective view of a main part of a motor 1 according to an exemplary embodiment of the present disclosure. FIG. 2 is a plan view of the main part of the motor 1. FIG. 3 is a cross-sectional view taken along the plane A-A in FIG. 2.

The motor 1 according to this embodiment includes a rotor 2 and a stator 3.

The rotor 2 includes a rotor yoke 22 having the shape of a column and a plurality of magnet 23.

The rotor yoke 22 has a rotary shaft 21, of which the rotational axis is defined by a center axis Ax1.

The plurality of magnets 23 are arranged on a side surface of the rotor yoke 22 to surround the circumference of the rotor yoke 22.

The stator 3 has a stator yoke 32 having the shape of a cylinder, a plurality of teeth 33, and a plurality of winding wires 34.

The stator yoke 32 is arranged to be concentric with the rotor 2.

The plurality of teeth 33 protrude toward the rotary shaft 21 from a plurality of points on the inner circumferential surface of the stator yoke 32. The plurality of points are set to face the circumference of the rotor yoke 22.

Each of the plurality of winding wires 34 is wound around a corresponding one of the plurality of teeth 33.

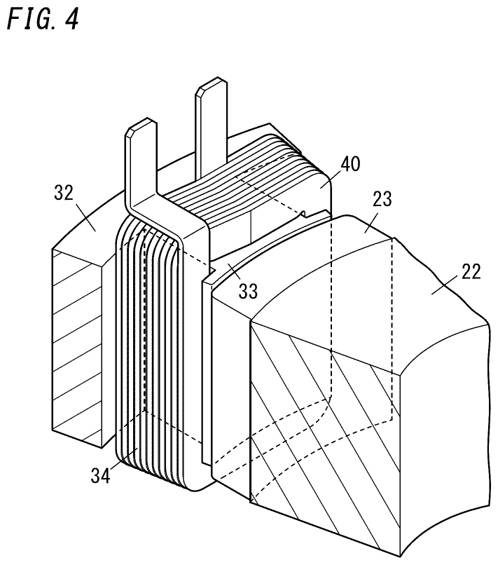

Each of the plurality of winding wires 34 is formed by winding, in multiple layers, a wire 40 having a flat and rectangular shape, and has a plurality of (e.g., eleven in FIG. 4) layers L1 to L11 which are stacked one on top of another in a direction in which a corresponding one of the plurality of teeth 33 protrudes.

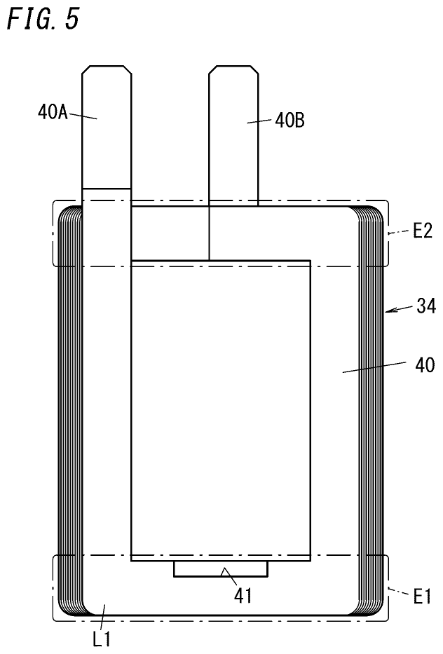

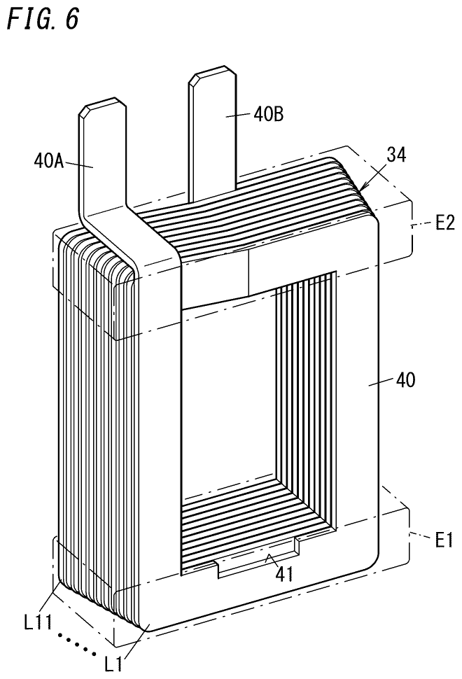

In each of the plurality of winding wires 34, a cutout 41 (refer to FIGS. 5 and 6) is provided for one or more layers L1 including a layer L1 closest to the rotor 2 which belong to the plurality of layers L1 to L11.

As used herein, the “axial direction” defined with respect to the rotary shaft 21 refers to a direction in which the rotary shaft 21 extends and is aligned with the center axis Ax1 of the rotary shaft 21. Also, on a plane intersecting at right angles with the center axis Ax1, the direction intersecting at right angles with the direction in which the center axis Ax1 extends and pointing radially outward from the center axis Ax1 will be hereinafter referred to as a “radial direction” defined with respect to the rotor yoke 22. The direction in which the rotor yoke 22 rotates on the center axis Ax1 of the rotary shaft 21, in other words, the direction defined along the circumference of the rotor yoke 22 will be hereinafter referred to as a “circumferential direction” defined with respect to the rotor yoke 22. As used herein, the phrase “intersecting at right angles” refers to not only a situation where the angle formed between two lines is exactly equal to 90 degrees but also a situation where the two lines intersect with each other at substantially right angles (hereinafter referred to as “two perpendicular lines”), of which the difference from 90 degrees falls within a certain tolerance range. That is to say, the angle formed between two perpendicular lines is different from 90 degrees by not more than the certain tolerance (e.g., equal to or less than 10 degrees). Also, each of the plurality of winding wires 34 has the plurality of layers L1 to L11 formed by the wire 40. The layer located closest to the rotor 2 which belongs to the plurality of layers L1 to L11 formed by the wire 40 will be hereinafter referred to as a “first layer L1,” and an n^{th} layer counted from the first layer L1 located closest to the rotor 2 will be hereinafter sometimes referred to as an “n^{th} layer Ln,” where n is a positive integer. Furthermore, a state of the winding wire wound around a tooth may refer to a state that the winding wire is wound around an insulator provided for the tooth which has electrical insulating properties or a state that the winding wire is directly wound around the tooth, the surface of which has been subjected to insulation process, whichever is appropriate.

In the motor 1 according to this embodiment, the cutout 41 is provided for one or more layers including the layer located closest to the rotor 2 (i.e., the first layer L1) which belong to the plurality of layers L1 to L11 formed by the wire 40 of the winding wire 34.

In each of the plurality of winding wires 34, a leakage flux emitted from one of the magnets 23 of the rotor 2 will be easily interlinked with one or more layers including the first layer L1 closest to the rotor 2. In this embodiment, the cutout 41 is provided for one or more layers including the first layer L1 in each of the plurality of winding wires 34. Thus, the distance between the winding wire 34 and the magnet 23 is longer than in a situation where no cutouts 41 are provided. Consequently, the leakage flux interlinked with the wire 40 of the winding wire 34 may be reduced, which allows for cutting down eddy current loss caused in the motor 1. Also, this embodiment eliminates the need to provide the recess for the teeth 33 as is done in the rotating electrical machine disclosed in Patent Literature 1. Therefore, this embodiment may reduce the degree of increase in the iron loss of the teeth 33 and thereby provide a motor 1 contributing to reducing the entire loss. In addition, the cutout 41 is provided for a part of one or more layers including the first layer L1 which belong to the plurality of layers L1 to L11 of the winding wire 34, thus also achieving the advantage of reducing the degree of increase in the DC resistance of the wire 40 forming the winding wire 34.

### (2) Details

Next, the motor 1 according to this embodiment will be described in further detail with reference to FIGS. 1-6.

The motor 1 according to this embodiment is, for example, an inner rotor type brushless motor including the stator 3 in which a rotor is disposed. This motor 1 is, for example, energized and driven by an alternating current with three phases (U-phase, V-phase, and W-phase) which are different from each other by 120 degrees.

The motor 1 includes the rotor 2, the stator 3, and a casing (not shown) housing the rotor 2 and stator 3 inside.

### (2.1) Rotor

The rotor 2 includes, as described above, the rotor yoke 22 and the plurality of magnets 23.

The rotor yoke 22 has the shape of a column, of which the center is defined by the center axis Ax1, and is formed in the shape of a column, of which the dimension in the axial direction is smaller than its dimension in the radial direction. The rotor yoke 22 is formed by, for example, stacking a plurality of non-oriented magnetic steel sheets in the axial direction. Note that the rotor yoke 22 may also be made of iron, silicon steel, permalloy, ferrite, or any other suitable material.

A circular hole (hereinafter referred to as a “center hole”) is provided through a central part of the rotor yoke 22. The rotary shaft 21 is inserted into the center hole of the rotor yoke 22, and the rotor yoke 22 is mounted onto the middle of the rotary shaft 21 in the axial direction. The rotor yoke 22 is fixed to the rotary shaft 21 and is designed to rotate on the center axis Ax1 along with the rotary shaft 21.

The rotor 2 is, for example, a surface magnet type rotor. The plurality of magnets 23 are mounted on the side surface of the rotor yoke 22 to be arranged side by side at regular intervals in the circumferential direction defined with respect to the rotor yoke 22. In this embodiment, ten magnets 23, for example, are mounted at regular intervals on the circumferential surface of the rotor yoke 22.

Each of the plurality of magnet 23 is, for example, a permanent magnet such as a neodymium magnet formed in the shape of a rectangular parallelepiped. The plurality of magnets 23 are mounted on the side surface of the rotor yoke 22 so that their N- and S-magnetic poles are alternately arranged in the circumferential direction defined with respect to the rotor yoke 22.

### (2.2) Stator

The stator 3 includes a stator core 31 and the plurality of winding wires 34.

The stator core 31 is configured as a combination of the above-described stator yoke 32 and plurality of teeth 33.

The stator yoke 32 is formed in a cylindrical shape. The stator yoke 32 is formed by, for example, stacking a plurality of non-oriented magnetic steel sheets in the axial direction defined with respect to the rotary shaft 21. The stator yoke 32 is arranged to be concentric with the rotor 2. In other words, the center axis of the stator yoke 32 having the shape of a cylinder is aligned with the center axis Ax1 of the rotary shaft 21 of the rotor yoke 22.

The plurality of teeth 33 protrude from the inner circumferential surface of the stator yoke 32 toward the rotary shaft 21 to be arranged side by side at regular intervals along the circumference of the rotor yoke 22. Each of the plurality of teeth 33 is fixed to the stator yoke 32 by, for example, fitting a part of the tooth 33 into a corresponding one of grooves provided in the stator yoke 32.

The plurality of teeth 33 are arranged side by side at regular intervals in the circumferential direction defined with respect to the rotor yoke 22. Each of the plurality of teeth 33 faces the rotor yoke 22 in the radial direction. Each of the plurality of winding wires 34 is wound around a corresponding one of the plurality of teeth 33 via the insulator having electrical insulating properties. The plurality of teeth 33 face the outer circumferential surface of the rotor 2 with gaps left when the rotor 2 is disposed inside the stator 3.

In this embodiment, twelve teeth 33, for example, are arranged side by side at regular intervals on the inner circumferential surface of the stator yoke 32. A corresponding one of the winding wires 34 is wound around each of the twelve teeth 33. The twelve winding wires 34 are grouped into three groups, each of which corresponds to one of the three phases. Each group consists of four winding wires 34 that are arranged side by side at regular intervals in the circumferential direction defined with respect to the rotor yoke 22.

FIG. 4 is a perspective view of a main part of the motor 1 in which one magnet 23 mounted on the rotor yoke 22 faces one of the teeth 33 of the stator 3. Also, FIG. 5 is a front view of only the winding wire 34, and FIG. 6 is a perspective view of only the winding wire 34.

The winding wire 34 is an edgewise winding wire formed by winding, in multiple layers, the wire 40 having a flat and rectangular shape (i.e., so-called a flat wire) which is made of, for example, copper or a copper alloy. Each of the plurality of winding wires 34 has a plurality of (e.g., eleven) layers L1 to L11 which are stacked one on top of another in a direction in which a corresponding one of the plurality of teeth 33 protrudes. Both ends of the wire 40 (i.e., a first end 40A and a second end 40B), serving as the winding wire 34, are extended, for example, in a direction parallel to the axial direction defined with respect to the rotary shaft 21.

The portions, located outside of the rotor yoke 22, of each of the winding wires 34 will be hereinafter referred to as “coil end portions E1, E2” when viewed in the radial direction defined with respect to the rotor yoke 22 (i.e., when viewed in plan in the radial direction defined with respect to the rotor yoke 22). In other words, the portions, not overlapping with the rotor yoke 22, of the winding wire 34 when viewed in plan in the radial direction defined with respect to the rotor yoke 22 will be hereinafter referred to as the “coil end portions E1, E2.” The coil end portions E1, E2 are portions that do not contribute to generating an effective magnetic field producing a rotating magnetic field that causes the rotor 2 to rotate. In this embodiment, the cutout 41 is provided for one coil end portion E1 (i.e., the lower one in FIG. 5) out of the coil end portions E1, E2 interposing the rotor yoke 22 on both sides. Stated otherwise, one or more layers of the winding wire 34 are provided with the cutout 41 at the coil end portion E1 thereof which is located outside of the rotor yoke 22 when viewed in the radial direction defined with respect to the rotor yoke 22.

Next, the reduction effect of an eddy current will be described with attention paid to a magnet 23A, facing two adjacent teeth 33A and 33B which belongs to the plurality of magnets 23 mounted on the rotor yoke 22, in a state where the rotating rotor 2 is currently located at the position shown in the FIG. 2. This effect will be produced by providing the cutouts 41. A magnetic flux B1 emitted from the magnet 23A is swept, for example, by the tooth 33A, and then returns to the magnet 23A from the adjacent tooth 33B via the stator yoke 32 in the situation where the magnet 23A faces the two adjacent teeth 33A and 33B. The flow of this magnetic flux B1 is called a “main magnetic flux,” which is used for rotating the rotor 2 and thereby outputting torque. On the other hand, the magnet 23A emits not only the main magnetic flux but also a leakage flux leaking to a region outside of the stator core 31. The leakage flux is mainly generated in the gap between the rotor 2 and the stator 3. Allowing this leakage flux to be interlinked with the winding wires 34, wound around the teeth 33A and the 33B, produces an eddy current in the winding wires 34 and consequently causes eddy current loss due to the production of this eddy current. This eddy current loss brings about generation of heat, thus possibly causing an increase in the temperature of the winding wires 34 and a decrease in the efficiency of the motor 1.

The motor 1 according to this embodiment uses the flat and rectangular wire 40 to form the winding wire 34 to increase the lamination factor and reduce the DC resistance of the winding wire 34. However, the flat and rectangular wire 40 makes the cross-sectional area, with which the leakage flux is interlinked, larger than in a situation where the wire 40 is a twisted wire or a round wire, thus possibly causing an increase in the eddy current. Therefore, in this embodiment, the cutout 41 is provided for a part, such as the coil end portion E1, of the winding wire 34, on which the leakage flux concentrates as shown in FIGS. 5 and 6. Providing the cutout 41 makes the gap between the magnet 23 and the winding wire 34 wider than in a situation where no cutouts 41 are provided. This may reduce the leakage flux interlinked with the winding wire 34, and consequently, may cut down the eddy current loss. In this embodiment, the cutout 41 is provided for the coil end portion E1. However, this should not be construed as limiting. Alternatively, the cutout 41 may also be provided for the coil end portion E2 or for both the coil end portions E1, E2.

Also, in this embodiment, the cutout 41 is provided for only the part (such as the layer located closest to the rotor 2 (i.e., the first layer L1) which belongs to the plurality of layers L1 to L11) on which the leakage flux concentrates, of the winding wire 34. Providing the cutout 41 for the first layer L1 of the winding wire 34 makes the gap between the magnet 23 and the winding wire 34 wider, and therefore, the leakage flux interlinked with the winding wire 34 may be reduced. As a result, the generation of the eddy current may be reduced, thus allowing the eddy current loss to be cut down. Note that a method for forming the cutout 41 in the winding wire 34 may be a punching process or a cutting process, and any appropriate method may be adopted.

Note that, in this embodiment, the cutout 41 is provided for the end portion, facing the tooth 33, of the first layer L1 of the winding wire 34. In other words, it is preferable that the cutout 41 be provided for the end portion, facing the tooth 33, of one or more layers of the winding wire 34. Providing the cutout 41 for the part, on which the leakage flux easily concentrates on one or more layers, of the winding wire 34 allows for reducing the leakage flux interlinked with the winding wire 34 and thereby cutting down the eddy current loss.

Note that the cutout 41 may also be provided, for the end portion, opposite from the end portion facing the tooth 33, of the one or more layers of the winding wire 34. That is to say, the part for which the cutout 41 is provided may be changed as appropriate.

In addition, it is not always necessary, in this embodiment, to provide the cutout 41 for one or more layers including the layer L1 located closest to the rotor 2 in all the winding wires 34 wound around the plurality of teeth 33. Alternatively, the cutout 41 may also be provided for one or more layers including the layer L1 located closest to the rotor 2 only in some of the plurality of winding wires 34 wound around the plurality of teeth 33.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure.

Next, variations of the exemplary embodiment will be enumerated one after another. Note that the variations to be described below may be adopted in combination as appropriate.

### (3.1) First Variation

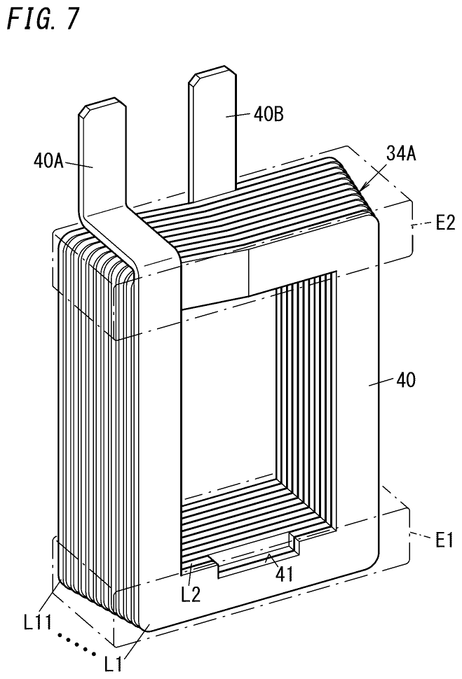

A winding wire 34A of a motor 1 according to a first variation of the exemplary embodiment will be described with reference to FIGS. 7-9. Note that the motor 1 according to the first variation has the same configuration as the motor 1 according to the exemplary embodiment described above except the winding wire 34A. Thus, in the following description, any constituent element of this first variation, having the same function as a counterpart of the embodiment described above, will be designated by the same reference numeral as that counterpart's, and description thereof will be omitted herein.

The cutout 41 is provided only for the first layer L1 in the winding wire 34 according to the above-described embodiment. On the other hand, the cutout 41 is provided for a plurality of layers including the first layer L1 in the winding wire 34A according to the first variation.

FIG. 7 is a perspective view of the winding wire 34A of the motor 1 according to the first variation. In the winding wire 34A shown in FIG. 7, the cutout 41 is provided for two layers (namely, the first layer L1 and a second layer L2) at the same position when viewed in the radial direction defined with respect to the rotor yoke 22.

As can be seen, providing the cutout 41 for a plurality of layers, including the first layer L1, of the winding wire 34A allows for further reducing the leakage flux interlinked with the winding wire 34A and thereby cutting down the eddy current loss more sufficiently.

Note that, in the plurality of layers of the winding wire 34A, the number of layers for which the cutout 41 is provided may be changed as appropriate.

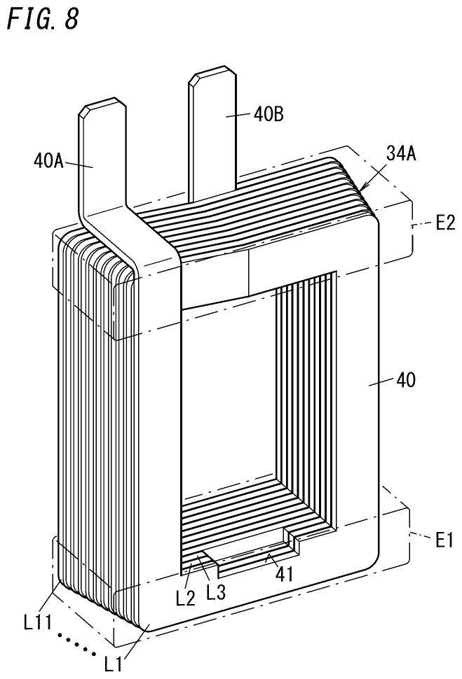

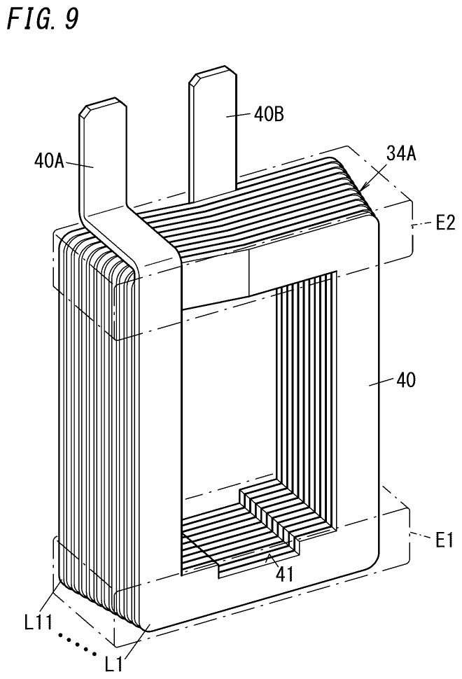

As shown in FIG. 8, the cutout 41 may also be provided for, for example, three layers (namely, the first layer L1 to a third layer L3) of the winding wire 34A at the same position when viewed in the radial direction defined with respect to the rotor yoke 22. Alternatively, as shown in FIG. 9, the cutout 41 may also be provided for all of the plurality of layers L1 to L11 of the winding wire 34A at the same position when viewed in the radial direction defined with respect to the rotor yoke 22. It is preferable that if the cutout 41 is provided for each of the plurality of layers, then the plurality of cutouts 41 be provided for the plurality of layers at the same position when viewed in the radial direction defined with respect to the rotor yoke 22.

In the winding wire 34A according to the first variation, the cutout 41 is provided for the end portion, facing the tooth 33, of the plurality of layers of the winding wire 34A. However, this should not be construed as limiting. Alternatively, the cutout 41 may also be provided for the other end portion opposite from the end portion facing the tooth 33. The position for which the cutout 41 is provided may be changed as appropriate.

In the winding wire 34A according to the first variation, the cutout 41 is provided for the coil end portion E1. However, this should not be construed as limiting. Alternatively, the cutout 41 may also be provided for the coil end portion E2 or for both the coil end portions E1, E2.

### (3.2) Second Variation

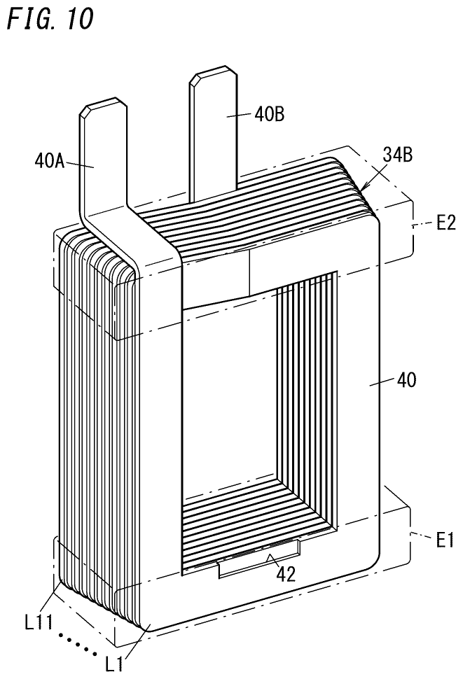

A winding wire 34B of a motor 1 according to a second variation of the exemplary embodiment will be described with reference to FIG. 10. Note that the motor 1 according to the second variation has the same configuration as the motor 1 according to the exemplary embodiment described above except the winding wire 34B. Thus, in the following description, any constituent element of this second variation, having the same function as a counterpart of the embodiment described above, will be designated by the same reference numeral as that counterpart's, and description thereof will be omitted herein.

In the motor 1 according to the second variation, the cutout 42 is provided to extend halfway through the thickness of the layer located closest to the rotor 2 (i.e., the first layer L1) out of the plurality of layers of the winding wire 34B. This is a difference from the above-described embodiment.

The cutout 42 is provided for only the first layer L1 of the winding wire 34B to extend halfway through the thickness of the first layer L1. As can be seen, the cutout 42 does not penetrate through the first layer L1 of the winding wire 34B, thus making the cross-sectional area of the first layer L1 larger than in the above-described embodiment in which the cutout 41 penetrates through the first layer L1. Therefore, in the motor 1 according to the second variation, providing the cutout 42 extending halfway through the thickness of the first layer L1 allows for reducing the leakage flux interlinked with the winding wire 34B and thereby cutting down the eddy current loss, while attempting to lower the resistance of the winding wire 34B.

In the winding wire 34B according to the second variation, the cutout 42 is provided for the end portion, facing the tooth 33, of the plurality of layers of the winding wire 34B. However, this should not be construed as limiting. Alternatively, the cutout 42 may also be provided for the other end portion opposite from the end portion facing the tooth 33. The position for which the cutout 42 is provided may be changed as appropriate.

In the winding wire 34B according to the second variation, the cutout 42 is provided for the coil end portion E1. However, this should not be construed as limiting. Alternatively, the cutout 42 may also be provided for the coil end portion E2 or for both the coil end portions E1, E2.

### (3.3) Third Variation

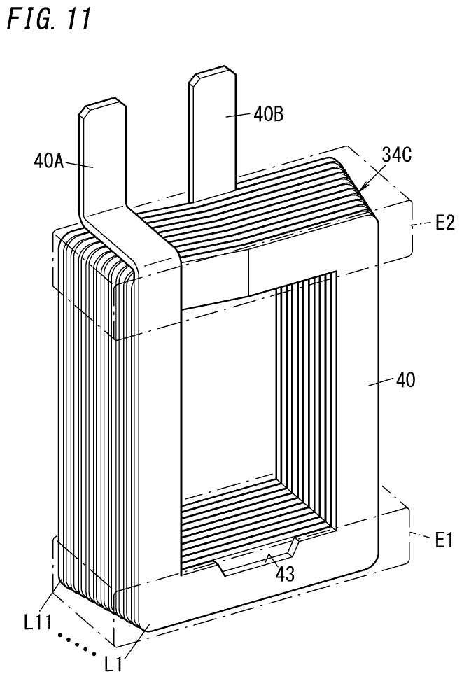

A winding wire 34C of a motor 1 according to a third variation of the exemplary embodiment will be described with reference to FIG. 11. Note that the motor 1 according to the third variation has the same configuration as the motor 1 according to the exemplary embodiment described above except the winding wire 34C. Thus, in the following description, any constituent element of this third variation, having the same function as a counterpart of the embodiment described above, will be designated by the same reference numeral as that counterpart's, and description thereof will be omitted herein.

In the above-described embodiment, the cutout 41 is formed by providing a rectangular recess for the end portion of the first layer L1 of the winding wire 34. However, the shape of the cutout may be changed as appropriate.

In the winding wire 34C according to the third variation, the cutout 43 is provided for the end portion, facing the tooth 33, of one or more layers. Also, in the winding wire 34C, the cutout 43 is shaped to increase its width (as measured in the direction in which the wire 40 is wound) in the direction pointing toward the corresponding tooth 33 when viewed in the radial direction defined with respect to the rotor yoke 22. Each of the ends of the cutout 43 is obliquely sloped with respect to the end face of the wire 40, thus achieving the advantage of forming the cutout 43 more easily than in a situation where the ends of the cutout 43 intersect at right angles with the end face of the wire 40.

Note that the shape of the cutout 43 shown in FIG. 11 is only an example and may be changed as appropriate.

In the winding wire 34C according to the third variation, the cutout 43 is provided for the coil end portion E1. However, this should not be construed as limiting. Alternatively, the cutout 43 may also be provided for the coil end portion E2 or for both the coil end portions E1, E2.

### (3.4) Fourth Variation

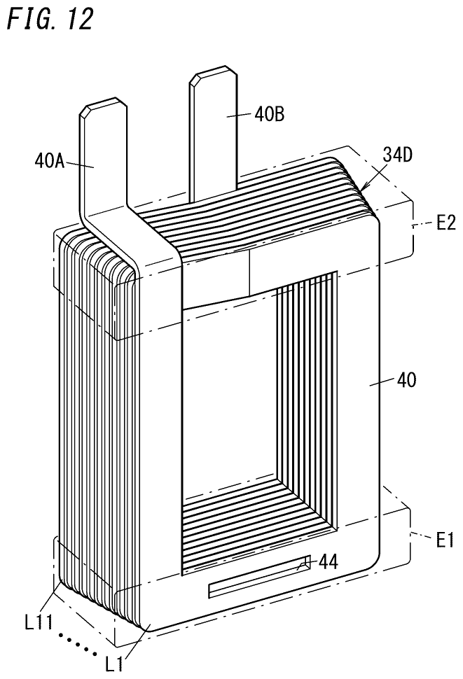

A winding wire 34D of a motor 1 according to a fourth variation of the exemplary embodiment will be described with reference to FIG. 12. Note that the motor 1 according to the fourth variation has the same configuration as the motor 1 according to the exemplary embodiment described above except the winding wire 34D. Thus, in the following description, any constituent element of this fourth variation, having the same function as a counterpart of the embodiment described above, will be designated by the same reference numeral as that counterpart's, and description thereof will be omitted herein.

In the above-described embodiment, the cutout 41 is formed by providing a recess for the end portion of the first layer L1 of the winding wire 34. However, the shape of the cutout may be changed as appropriate.

In the winding wire 34D according to the fourth variation, the cutout 44 is provided through the first layer L1 as a through-hole penetrating through the first layer L1 to be located at the middle of the width (as measured in a direction perpendicular to the direction in which the wire 40 is wound) of the wire 40. That is to say, in the fourth variation, the cutout 44 is a hole of which circumference is closed. As can be seen, even such a configuration that the cutout 44 is provided as a hole, of which the circumference is closed, still allows for reducing the leakage flux interlinked with the winding wire 34D and thereby cutting down the eddy current loss, compared to a situation where the cutout 44 is not provided.

Note that, the cutout 44 penetrates through only the first layer L1 of the winding wire 34D. However, this should not be construed as limiting. Alternatively, the cutout 44 may also be formed to penetrate through a plurality of layers included in the winding wire 34D.

Note that, the cutout 44 is provided for the coil end portion E1. However, this should not be construed as limiting. Alternatively, the cutout 44 may also be provided for the coil end portion E2 or for both the coil end portions E1, E2. Optionally, the cutout 44 may also be a hole penetrating through a plurality of layers including the first layer L1.

### (3.5) Fifth Variation

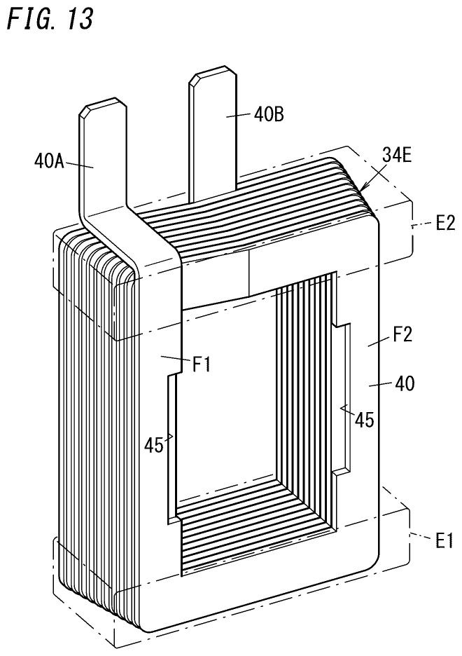

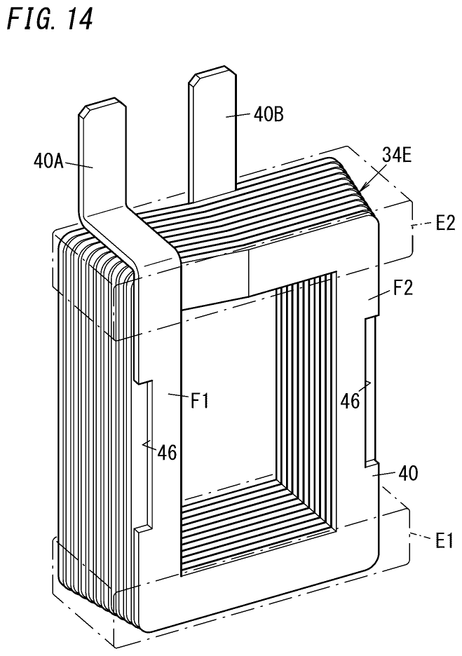

A winding wire 34E of a motor 1 according to a fifth variation of the exemplary embodiment described above will be described with reference to FIGS. 13 and 14. Note that the motor 1 according to the fifth variation has the same configuration as the motor 1 according to the exemplary embodiment described above except the winding wire 34E. Thus, in the following description, any constituent element of this fifth variation, having the same function as a counterpart of the embodiment described above, will be designated by the same reference numeral as that counterpart's, and description thereof will be omitted herein.

In the above-described embodiment, the cutout 41 is provided for the coil end portion E1 of the winding wire 34. On the other hand, in the fifth variation, a cutout 45 (refer to FIG. 13) is provided for an intermediate parts F1, F2 between the coil end portions E1 and E2 of the first layer L1 of the winding wire 34E. That is to say, each of the cutouts 45 is provided for the corresponding one of the two intermediate parts F1, F2, which face each other in the circumferential direction defined with respect to the rotor yoke 22, of the first layer L1 of the winding wire 34E. More specifically, each of the cutouts 45 is provided for the corresponding one of the respective end portions, facing the tooth 33, of the intermediate parts F1, F2 of the first layer L1 of the winding wire 34E. Providing the cutouts 45 for the intermediate parts F1, F2, respectively, allows for reducing the leakage flux interlinked with the winding wire 34E and thereby cutting down the eddy current loss.

Alternatively, as shown in FIG. 14, each of cutouts 46 may also be provided for a corresponding one of the end portions, located opposite from the end portions facing the tooth 33, of the intermediate parts F1, F2 of the first layer L1 of the winding wire 34E.

Note that the cutouts 45, 46 do not have to be provided for the intermediate parts F1, F2 of only the first layer L1 of the winding wire 34E. Alternatively, the cutouts 45, 46 may also be provided for a plurality of layers of the winding wire 34E. The cutouts 45, 46 do not have to be provided for both intermediate parts F1, F2 of the winding wire 34E. Alternatively, the cutout 45, 46 may also be provided only for one of the intermediate parts F1, F2.

### (3.6) Sixth Variation

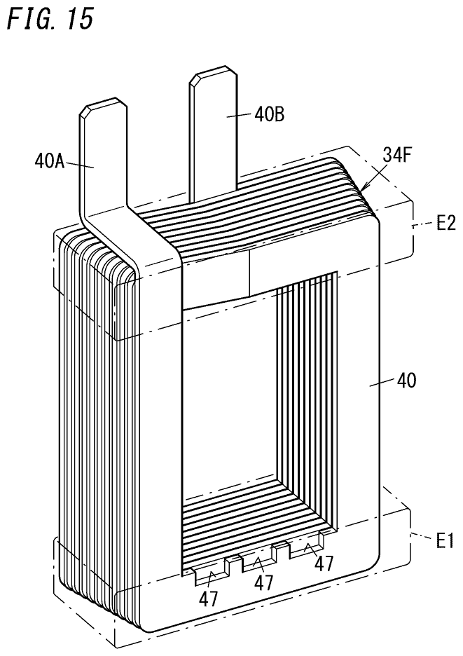

A winding wire 34F of a motor 1 according to a sixth variation of the exemplary embodiment will be described with reference to FIG. 15. Note that the motor 1 according to the sixth variation has the same configuration as the motor 1 according to the exemplary embodiment described above except the winding wire 34F. Thus, in the following description, any constituent element of this sixth variation, having the same function as a counterpart of the embodiment described above, will be designated by the same reference numeral as that counterpart's, and description thereof will be omitted herein.

In the above-described embodiment, the cutout 41 is provided at one position of the coil end portion El for the first layer L1 of the winding wire 34F. However, this is only an example and should not be construed as limiting. Rather, the position and the number of the cutout(s) may be changed as appropriate.

In the sixth variation, as shown in FIG. 15, three cutouts 47 are provided at a plurality of positions (e.g., three positions) of the coil end portion El for the first layer L1 of the winding wire 34F.

As can be seen, the cutouts 47 may be provided at a plurality of positions in the direction in which the wire 40 is wound for one or more layers out of plurality of layers included in the winding wire 34F. This allows for reducing the leakage flux interlinked with the winding wire 34F and thereby cutting down the eddy current loss.

Note that, in the above-described first to fifth variations, the number and the position(s) of the cutouts 41-46 may be changed as appropriate. Optionally, a plurality of cutouts 41-46 may be provided for one or more layers including at least the first layer L1.

Also, in the above-described first to sixth variations, the cutout 41 may be provided for one or more layers, including the layer L1 closest to the rotor 2, of only some of the plurality of winding wires 34A-34F wound around the plurality of teeth 33.

### Recapitulation

The exemplary embodiment and its variations described above are specific implementations of the following aspects of the present disclosure.

A motor (1) according to a first aspect includes a rotor (2) and a stator (3). The rotor (2) includes: a rotor yoke (22) having the shape of a column and including a rotary shaft (21), of which a rotational axis is defined by a center axis (Ax1); and a plurality of magnets (23) arranged on a side surface of the rotor yoke (22) to surround the circumference of the rotor yoke (22). The stator (3) includes: a stator yoke (32) having the shape of a cylinder; a plurality of teeth (33); and a plurality of winding wires (34, 34A-34F). The stator yoke (32) is arranged to be concentric with the rotor (2). The plurality of teeth (33) protrude toward the rotary shaft (21) from a plurality of points on the inner circumferential surface of the stator yoke (32). The plurality of points are set to face the circumference of the rotor yoke (22). Each of the plurality of winding wires (34, 34A-34F) is wound around a corresponding one of the plurality of teeth (33). Each of the plurality of winding wires (34, 34A-34F) is formed by winding, in multiple layers, a wire (40) having a flat and rectangular shape. Each of the plurality of winding wires (34, 34A-34F) has a plurality of layers (L1-L11) stacked one on top of another in a direction in which a corresponding one of the plurality of teeth (33) protrudes. Each of the plurality of winding wires (34, 34A-34F) has a cutout (41-47) provided for one or more layers (L1-L11) including a layer (L1) closest to the rotor (2) which belong to the plurality of layers (L1-L11).

This aspect may make the gap distance between each winding wire (34, 34A-34F) and a magnet (23) longer than in a situation where no cutouts (41-47) are provided. Consequently, the leakage flux interlinked with the winding wire (34, 34A-34F) may be reduced, which allows for cutting down the eddy current loss more sufficiently.

In a motor (1) according to a second aspect, which may be implemented in conjunction with the first aspect, the cutout (41-43, 45, and 47) is provided for an end portion, facing the corresponding one of the plurality of teeth (33), of the one or more layers (L1-L11).

According to this aspect, providing the cutout (41-43, 45, and 47) for the part, on which the leakage flux tends to concentrate, allows for reducing the leakage flux interlinked with the winding wire (34, 34A-34C, 34E, and 34F), thus further cutting down the eddy current loss.

In a motor (1) according to a third aspect, which may be implemented in conjunction with the second aspect, the cutout (43) is shaped to have a width thereof increased in a direction pointing toward a corresponding one of the plurality of teeth (33) when viewed in a radial direction defined with respect to the rotor yoke (22). The width is measured in a direction in which the wire (40) is wound.

This aspect achieves the advantage of forming the cutout (43) more easily.

In a motor (1) according to a fourth aspect, which may be implemented in conjunction with any one of the first to third aspects, the cutout (41-47) is provided for only the layer (L1) located closest to the rotor (2) which belongs to the plurality of layers (L1-L11).

This aspect allows for reducing the leakage flux interlinked with the winding wire (34, 34A-34F) and thereby further cutting down the eddy current loss, while attempting to lower the resistance of the winding wire (34, 34B-34F).

In a motor (1) according to a fifth aspect, which may be implemented in conjunction with the fourth aspect, the cutout (42) is provided to extend halfway through a thickness of the layer (L1) located closest to the rotor (2) out of the plurality of layers (L1-L11).

This aspect allows for reducing the leakage flux interlinked with the winding wire (34B) and thereby further cutting down the eddy current loss, while attempting to lower the resistance of the winding wire (34B).

In a motor (1) according to a sixth aspect, which may be implemented in conjunction with any one of the first to third aspects, the cutout (44) is a hole, of which the circumference is closed.

This aspect allows for reducing the leakage flux interlinked with the winding wire (34D) and thereby further cutting down the eddy current loss.

In a motor (1) according to a seventh aspect, which may be implemented in conjunction with any one of the first to sixth aspects, the one or more layers (L1-L11) are provided with the cutouts (47) at a plurality of positions in a direction in which the wire (40) is wound.

This aspect allows for reducing the leakage flux interlinked with the winding wire (34F) and thereby further cutting down the eddy current loss.

In a motor (1) according to an eighth aspect, which may be implemented in conjunction with any one of the first to seventh aspects, the one or more layers (L1-L11) are provided with the cutout (41-44, 47) at a coil end portion (E1, E2), located outside of the rotor yoke (22), when viewed in the radial direction defined with respect to the rotor yoke (22).

According to this aspect, providing the cutout (41-44, 47) for the coil end portion (E1, E2), on which the leakage flux tends to concentrate, allows for reducing the leakage flux interlinked with the winding wire (34, 34A-34D, 34F) and thereby further cutting down the eddy current loss.

Note that the constituent elements according to the second to eighth aspects are not essential constituent elements for the motor (1) but may be omitted as appropriate.

### REFERENCE SIGNS LIST

1 Motor

2 Rotor

3 Stator

21 Rotary Shaft

22 Rotor Yoke

23 Magnet

32 Stator Yoke

33 Tooth

34, 34A-34F Winding Wire

40 Wire

41-47 Cutout

Ax1 Center Axis

E1, E2 Coil End Portion

L1-L11 Layer

1. A motor comprising
a rotor and
a stator,
the rotor including:
a rotor yoke having a shape of a column and including a rotary shaft, the rotary shaft having a rotational axis thereof defined by a center axis; and
a plurality of magnets arranged on a side surface of the rotor yoke to surround a circumference of the rotor yoke,
the stator including:
a stator yoke arranged to be concentric with the rotor and having a shape of a cylinder;
a plurality of teeth protruding toward the rotary shaft from a plurality of points on an inner circumferential surface of the stator yoke, the plurality of points being set to face the circumference of the rotor yoke; and
a plurality of winding wires, each of the plurality of winding wires being wound around a corresponding one of the plurality of teeth,
each of the plurality of winding wires being formed by winding, in multiple layers, a wire having a flat and rectangular shape, each of the plurality of winding wires having a plurality of layers stacked one on top of another in a direction in which a corresponding one of the plurality of teeth protrudes, and
each of the plurality of winding wires having a cutout, the cutout being provided for one or more layers including a layer closest to the rotor which belong to the plurality of layers.

2. The motor of claim 1, wherein
the cutout is provided for an end portion, facing the corresponding one of the plurality of teeth, of the one or more layers.

3. The motor of claim 2, wherein
the cutout is shaped to have a width thereof increased in a direction pointing toward a corresponding one of the plurality of teeth when viewed in a radial direction defined with respect to the rotor yoke, the width being measured in a direction in which the wire is wound.

4. The motor of claim 1, wherein
the cutout is provided for only the layer located closest to the rotor which belongs to the plurality of layers.

5. The motor of claim 4, wherein
the cutout is provided to extend halfway through a thickness of the layer located closest to the rotor out of the plurality of layers.

6. The motor of claim 1, wherein the cutout is a hole, of which circumference is closed.

7. The motor of claim 1, wherein the one or more layers are provided with the cutouts at a plurality of positions in a direction in which the wire is wound.

8. The motor of claim 1, wherein
the one or more layers are provided with the cutout at a coil end portion, located outside of the rotor yoke, when viewed in the radial direction defined with respect to the rotor yoke.

9. The motor of claim 2, wherein
the cutout is provided for only the layer located closest to the rotor which belongs to the plurality of layers.

10. The motor of claim 3, wherein the cutout is provided for only the layer located closest to the rotor which belongs to the plurality of layers.

11. The motor of claim 2, wherein
the cutout is a hole, of which circumference is closed.

12. The motor of claim 3, wherein
the cutout is a hole, of which circumference is closed.

13. The motor of claim 2, wherein
the one or more layers are provided with the cutouts at a plurality of positions in a direction in which the wire is wound.

14. The motor of claim 3, wherein
the one or more layers are provided with the cutouts at a plurality of positions in a direction in which the wire is wound.

15. The motor of claim 4, wherein
the one or more layers are provided with the cutouts at a plurality of positions in a direction in which the wire is wound.

16. The motor of claim 5, wherein
the one or more layers are provided with the cutouts at a plurality of positions in a direction in which the wire is wound.

17. The motor of claim 6, wherein
the one or more layers are provided with the cutouts at a plurality of positions in a direction in which the wire is wound.

18. The motor of claim 2, wherein
the one or more layers are provided with the cutout at a coil end portion, located outside of the rotor yoke, when viewed in the radial direction defined with respect to the rotor yoke.

19. The motor of claim 3, wherein
the one or more layers are provided with the cutout at a coil end portion, located outside of the rotor yoke, when viewed in the radial direction defined with respect to the rotor yoke.

20. The motor of claim 4, wherein
the one or more layers are provided with the cutout at a coil end portion, located outside of the rotor yoke, when viewed in the radial direction defined with respect to the rotor yoke.
